(19) United States
(12) Patent Application Publication
(10) Pub. No.: US 2017/0170906 A1
(43) Pub. Date: Jun. 15, 2017

(54) CODED LIGHT SYMBOL ENCODING

(71) Applicant: Philips Lighting Holding B.V., Eindhoven (NL)

(72) Inventor: Koen Johanna Guillaume HOLTMAN, Eindhoven (NL)

(21) Appl. No.: 15/322,464

(22) PCT Filed: Jun. 24, 2015
(86) PCT No.: PCT/EP2015/064169

§ 371 Date: Dec. 28, 2016

(30) Foreign Application Priority Data
Jul. 3, 2014 (EP) 14175671.8

(51) Int. Cl. H04B 10/516; H04B 10/116; H04N 5/235

(52) U.S. Cl. CPC H04B 10/516; H04N 5/2353; H04B 10/116

(57) ABSTRACT

The disclosure relates to symbols of data being encoded into visible light emitted by a light source, at a symbol rate f_{sym} having a symbol period T_{sym}=1/f_{sym}. Each of the symbols is encoded as one of a set of at least two different symbol waveforms formed in a level of the emitted light as a function of time, each of the symbol waveforms representing a respective one of a corresponding set of different data values. The difference between the symbol waveforms, which represents the different data values, is formed only within a predetermined time window at a given phase within the symbol period, the predetermined time window having a duration less than 0.75·T_{sym}, the light level inside this time window being substantially different for the different symbol waveforms, and the light level outside the time window being substantially the same for the different symbol waveforms.

### TECHNICAL FIELD

The present disclosure relates to an encoding scheme for modulating symbols of data into the light emitted by a light source.

### BACKGROUND

Coded light refers to techniques whereby data is embedded in the light emitted by a light source such as an everyday luminaire. The light typically comprises both a visible illumination contribution for illuminating a target environment such as room (typically the primary purpose of the light), and an embedded signal for providing information into the environment. To do this, the light is modulated at a certain modulation frequency or frequencies, preferably a high enough frequency so as to be beyond human perception and therefore not affecting the primary illumination function. In some cases, a coded light emitter might not have an illumination function at all. In that case, visible light or invisible infra-red light can be used as the medium for transmitting information.

Coded light can be used for a number of applications. For example, the data embedded in the light may comprise an identifier of the light source emitting that light. This identifier can then be used in a commissioning phase to identify the contribution from each luminaire, or during operation can be used to identify a luminaire in order to control it remotely (e.g. via an RF back channel). In another example, the identification can be used for navigation or other location-based functionality, by providing a mapping between the identifier and a known location of the light source, and/or other information associated with the location. In this case a device such as a mobile phone or tablet receiving the light (e.g. through a built-in camera) can detect the embedded identifier and use it to look up the corresponding location and/or other information mapped to the identifier (e.g. in a location database accessed over a network such as the Internet). In yet further applications, other information can be directly encoded into the light (as opposed to being looked up based on an ID embedded in the light).

WO2012/127439 discloses a technique whereby coded light can be detected using an everyday ‘rolling shutter’ type camera, as is often integrated into a mobile device like a mobile phone or tablet. In a rolling-shutter camera, the camera's image capture element is divided into a plurality of lines (typically horizontal lines, i.e. rows) which are exposed in sequence line-by-line. That is, to capture a given frame, first one line is exposed to the light in the target environment, then the next line in the sequence is exposed at a slightly later time, and so forth. Typically the sequence ‘rolls’ in order across the frame, e.g. in rows top to bottom, hence the name ‘rolling shutter’. When used to capture coded light, this means different lines within a frame capture the light at different times and therefore, if the line rate is high enough relative to the modulation frequency, at different phases of the modulation waveform. Thus the modulation in the light can be detected.

It is generally desirable to be able to detect a coded light signal in as few lines of the rolling-shutter camera as possible. For example, this can reduce the amount of time needed to detect the signal, which can be desirable for its own sake (speedier detection) and/or to save power (by reducing the amount of time the camera needs to be turned on and/or reducing the amount of signal processing required). As another consideration, being able to detect a coded light signal from a smaller number of lines may allow the signal to be detected from a light source having a smaller footprint in the captured image.

However, conventionally the effect of aliasing limits the symbol rate to being no more than half the sampling rate. In the case of detecting coded light using a rolling-shutter camera, this means capturing at least two lines per symbol of data, and in practice more than two lines per symbol. If the symbol sending clock and the sampling clock are exactly synchronized in frequency and phase, then is possible to cleanly sample symbols without aliasing. However, such synchronization is not always convenient or even possible depending on the scenario. It would be desirable to be able to communicate a coded light signal at a rate of more than one symbol per two lines, i.e. more than half the line rate, without (necessarily) requiring synchronization between the encoded signal and the sampling. Further, not just for detection using rolling-shutter cameras but also for detection using other types of light sensor (e.g. a slowly sampling photocell), it would be desirable to be able to communicate a coded light signal at a rate of more than one symbol per two samples, i.e. more than half the sample rate, again without (necessarily) requiring synchronization between the encoded signal and the sampling.

### SUMMARY

According to one aspect disclosed herein, there is provided an encoder for encoding symbols of data into light emitted by a light source. The encoder is configured to encode the symbols into the light at a symbol rate f_{sym} having a symbol period T_{sym}=1/f_{sym}; and each of said symbols is encoded as one of a set of at least two different symbol waveforms formed in a level of the emitted light as a function of time, each of the symbol waveforms representing a respective one of a corresponding set of different data values. The difference between the symbol waveforms, which represents the different data values, is formed only within a predetermined time window at a given phase within the symbol period, the predetermined time window having a duration less than 0.2·T_{sym}, the light level inside said time window being substantially different for the different symbol waveforms, and the light level outside said time window being substantially the same for the different symbol waveforms.

According to another aspect disclosed herein, there is provided a decoder for decoding symbols of data encoded into light emitted by a light source. The decoder is operable to obtain samples of the light sampled at a sample rate fₛₐₘₚ having a sample period Tₛₐₘₚ=1/fₛₐₘₚ (e.g. the line rate fₗᵢₙₑ of a rolling-shutter camera having a line period 1/Tₗᵢₙₑ); the symbols are encoded in the light at a symbol rate f_{sym} having a symbol period T_{sym}=1/f_{sym}; and each of said symbols is encoded as one of a set of at least two different symbol waveforms formed in a level of the emitted light as a function of time, each of the symbol waveforms representing a respective one of a corresponding set of different data values. The difference between the symbol waveforms, which represents the different data values, is formed only within a predetermined time window at a given phase within the symbol period, the predetermined time window having a duration less than or equal to 0.2·T_{sym} (which in embodiments will also be less than or equal to 0.2·Tₛₐₘₚ, e.g. less than or equal to 0.2·Tₗᵢₙₑ in the case of a rolling shutter camera) The light level inside said time window is substantially different for the different symbol waveforms, and the light level outside said time window is substantially the same for the different symbol waveforms. The decoder is configured to detect the data values represented by the symbol waveforms of the symbols, based on a quantity of light sampled during each of a plurality of respective instances of the sample period.

As will be exemplified in more detail in the Figures and Detailed Description section, this symbol set provides a ‘spiked’ code whereby a ‘clear space’ is left between locations where narrow pulses (or ‘spikes’) are used to encode the actual data. Advantageously, the inventor has found that leaving this clear space between the data-encoding regions of the symbol periods allows the data to be encoded at symbol rate higher than half the sample rate (more than one symbol per two samples, e.g. per two lines of a rolling shutter camera). I.e. there is a region in each symbol period which has the same (clear′) signal level as in every other symbol period, and it is having this clear region, at the same or roughly the same symbol clock phase offset relative to the next symbol, that gives the code its ‘anti-aliasing’ or ‘cross symbol interference reducing’ properties. In general, the greater the clear space, the more effective the anti-aliasing or reduction in cross-symbol interference. Therefore in embodiments, the duration of said predetermined time window is less than or equal to 0.1·T_{sym} or even 0.05·T_{sym}; and at the decode side is preferably also less than or equal to 0.1·Tₛₐₘₚ or even 0.05·Tₛₐₘₚ (e.g. less than or equal to 0.1·Tₗᵢₙₑ or even 0.05·Tₗᵢₙₑ). However, if the window size is made too small, then the symbol information may no longer be detectable by some detectors, because the energy difference between the symbols falls below the signal to noise ratio of the detector. So when choosing the window size, a trade-off may be made between having smaller windows (better anti-aliasing properties) and larger windows (better support for detectors or detecting environments with a higher noise floor).

In embodiments, the sample rate fₛₐₘₚ is greater than or equal to the symbol rate f_{sym}. I.e. the data may be encoded at a rate of up to one symbol per sample (e.g. per line of a rolling-shutter camera). For example in one particularly advantageous embodiment, to ensure there is no aliasing, the sample period Tₛₐₘₚ is less than or equal to T_{sym} minus the duration of the predetermined time window. Alternatively however, in some other embodiments the sample rate fₛₐₘₚ (e.g. line rate fₗᵢₙₑ) may in fact be less than the symbol rate f_{sym}, with the decoder comprising an error correction algorithm to correct for samples missed due to the lower line rate.

In fact, in embodiments error correcting codes may be useful both if the sample rate is a higher than the symbol rate, or lower; and in either case the decoder may be provided with an error correction algorithm to correct for symbols missed due to cross-symbol interference.

In embodiments, the symbols are not necessarily binary. I.e. each of said symbols may be encoded as one of a set of three or more symbol waveforms formed in the level of the emitted light, each of the three or more symbol waveforms representing a respective one of a corresponding set of different data values.

In further embodiments, the encoder may be configured to alter the phase at least once, and to continue said encoding with the altered phase. For example the encoder may be configured to alter the phase after transmitting the data at least once, and to repeat said encoding of the data with the altered phase (i.e. using the same encoding scheme but a different phase). This way if the decoder fails to detect the data from one the image captured in one frame due to the symbol pulses straddling the line samples, then the decoder may reattempt detection in a subsequent frame and this time successfully achieve detection as the symbols are now at a new phase and therefore a new time-alignment relative to the sampling.

Alternatively or additionally, the encoder may be configured to alter the symbol rate of said time window at least once, and to continue said encoding with the altered symbol rate. For example, the encoder may be configured to alter the symbol rate of said time window after transmitting the data at least once, and to repeat said encoding of the data with the altered symbol rate (i.e. using the same encoding scheme but a different symbol rate).

In yet further embodiments, in the case of detection using a rolling-shutter camera, each line is exposed for an exposure time Tₑₓₚ that equal to the line period Tₗᵢₙₑ. Alternatively, each line may be exposed for an exposure time Tₑₓₚ that is greater than the line period Tₗᵢₙₑ; with the decoder comprising a filter arranged to filter measurements from said plurality of lines in order to obtain said samples, such that each of said samples after said filtering represents an intensity of the light as received during a respective time period shorter than the exposure time Tₑₓₚ—in embodiments representing the light intensity received during a respective instance of Tₗᵢₙₑ (though some viable filters could have an output sample frequency different from the line rate).

In embodiments, the camera may be configured to capture pixels from only a sub-region of the image sensor (a “region of interest”), wherein the sub-region comprises or consists of a region in which the light source appears. I.e. the sub-region corresponds to the footprint of the light source on the image sensor, or a somewhat wider region around the light source's footprint containing the footprint and some background but nonetheless excluding one more other regions.

According to another aspect disclosed herein, there is provided a system comprising: a light source comprising the encoder, at least one light emitting element for emitting said light, and a driver coupled between the encoder and the at least one light emitting element via which the encoder is arranged to encode the symbols into the emitted light; and receiving equipment comprising the decoder and the rolling-shutter camera.

According to another aspect disclosed herein, there is provided a corresponding method of encoding, method of decoding, computer program product for encoding, and computer program product for decoding, in accordance with any of the encoder or decoder side features disclosed herein. In the case of a computer program product, this comprises software embodied on one or more computer readable media, arranged to be downloaded or otherwise retrieved therefrom, and configured so as when executed on one or more processors to perform the relevant encoder or decoder side operations.

### BRIEF DESCRIPTION OF THE DRAWINGS

To assist the understanding of the present disclosure and to show how embodiments may be put into effect, reference is made by way of example to the accompanying drawings in which:

FIG. 1 is a schematic illustration of an environment in which one or more light sources emit coded light, which is detected by a device with a rolling shutter camera;

FIG. 2 is a schematic representation of an image of the one or more light sources as captured by the rolling shutter camera;

FIG. 3 is a schematic representation of a portion of the image captured by the rolling shutter camera, including individual lines of the rolling shutter image sensor;

FIG. 4 is a sketch showing the intensity of the emitted light over time, and the corresponding amount of light measured by each line of the rolling shutter camera;

FIG. 5 is a sketch schematically showing the intensity of light emitted by a coded light source using an alternative coding scheme, and the corresponding amount of light measured by each line of the rolling shutter camera;

FIG. 6 is a sketch schematically showing the intensity of light emitted by a coded light source using another alternative coding scheme, and again the corresponding amount of light measured by each line of the rolling shutter camera;

FIG. 7 is a schematic block diagram of a system comprising a light source and receiving device;

FIG. 8 is a timing diagram schematically illustrating a rolling-shutter image capture process;

FIG. 9 is a timing diagram schematically illustrating the sampling of a series of coded light symbols over a sequence of rolling-shutter lines;

FIG. 10 is another timing diagram schematically illustrating the sampling of a series of coded light symbols over a sequence of rolling-shutter lines;

FIG. 11 is another timing diagram schematically illustrating the sampling of a series of coded light symbols over a sequence of rolling-shutter lines;

FIG. 12 is yet another timing diagram schematically illustrating the sampling of a series of coded light symbols over a sequence of rolling-shutter lines;

FIG. 13 is a sketch schematically illustrating an example symbol set;

FIG. 14 is a sketch schematically illustrating another example symbol set;

FIG. 15 is a sketch schematically illustrating yet another example symbol set; and

FIG. 16 is a graph of some experimental results.

### DETAILED DESCRIPTION OF EMBODIMENTS

The following describes an example in which coded light is used for indoor navigation. However, it will be appreciated that there will be many other applications that can benefit from being able to detect a coded light signal in fewer lines of a rolling shutter camera, or more generally fewer samples of a light sensor.

There are several ways for a device to determine its location, such as GPS. However, indoors GPS does not work very well. The current industry consensus is that indoors, a combination of sensing modalities in a smartphone should preferably be used to get the most accurate location determination, at the lowest power consumption. Such sensing modalities include:
Cell phone tower identity and signal strength measurement;
WiFi access point identity and signal strength measurement;
Accelerometer and gyroscope (gyroscopes not yet common in smart phones, but are increasingly being incorporated);
Bluetooth based location beacons, if available; and/or
Coded-light based location beacons, if available.

The coded light may be read with a high sample rate photodiode (not yet available in most smartphones), or may be read using a smartphone's inbuilt camera. N.B. the following will be described in terms of a smartphone, but it will be understood that the teachings can equally be applied to other types of receiving apparatus, e.g. other mobile devices such as tablets, laptops, headphones, remote controls, key fobs, smart watches or other “smart” apparel.

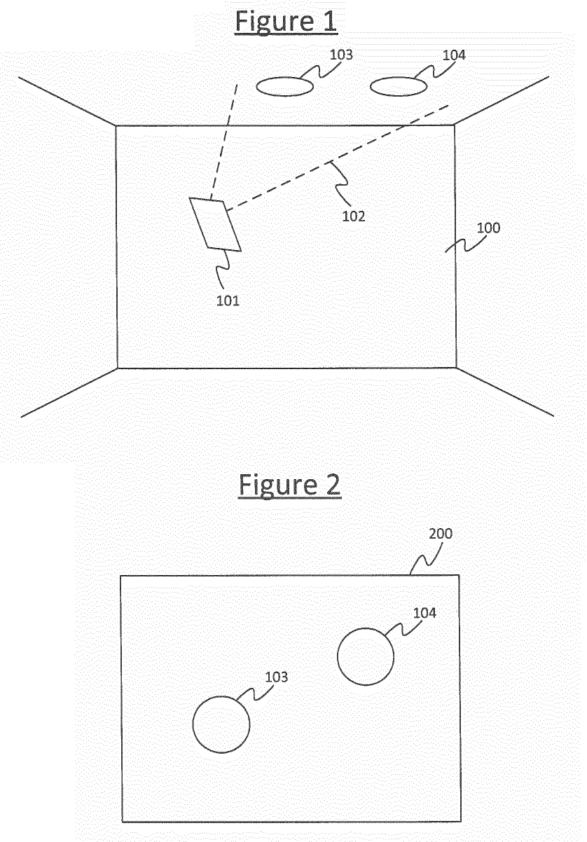

FIG. 1 illustrates the detection of coded light using the camera of smartphone 101. The smartphone 101 has a camera field of view 102 in which one or more light sources 103, 104 appear. At least one of the light sources 103, 104 is a coded light source 104 set up to transmit an identifier (and/or other information) embedded in the illumination it emits.

In embodiments the light sources 103, 104 are luminaires having a primary purpose of illuminating an indoor or outdoor environment 100, such that the at least one coded light source 104 embeds the identifier and/or other information in the visible illumination it emits. Alternatively, it is not excluded that the at least one light source 104 could be a dedicated coded light source having a primary purpose of transmitting information via visible or infrared (IR) light. E.g. low cost CMOS cameras that can detect IR light also exist, so the techniques disclosed herein could also apply to an application where IR light is used to create ‘invisible’ beacons, such as in an augmented reality gaming situation.

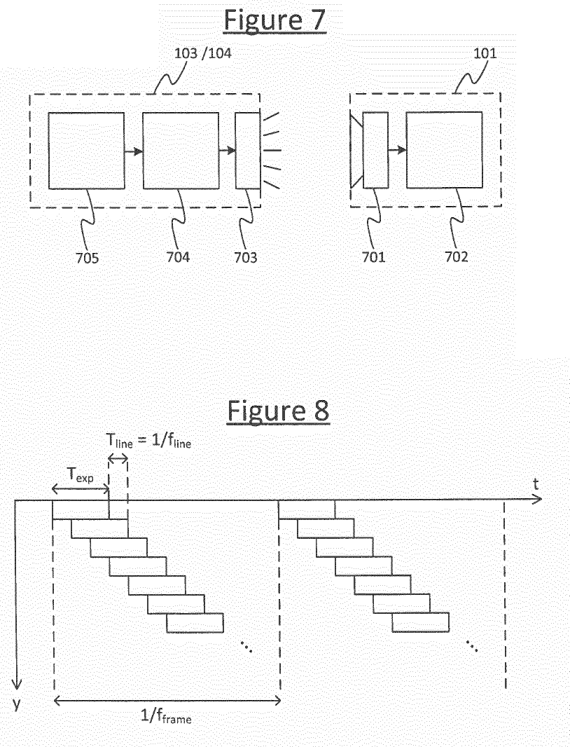

FIG. 7 shows more detail of the light source 104 (or 103) and the smartphone 101. The light source 104 comprises at least one light emitting element 703 (e.g. an LED or array of LEDs), a driver 704 having an output coupled to an input of the at least one lighting element 703, and an encoder 705 having an output coupled to an input of the driver 704. The encoder 705 is configured to control the at least one light source 703, via the driver 704, to modulate its light emission at a high frequency so as to embed data such as an identifier of the light source 104. The encoder 705 may be a local or remote component of the light source 104, or a combination of local and remote components. It may be implemented in software stored on one or more memories and arranged for execution on one or more processors, or it may be implemented in dedicated hardware circuitry, or configurable or reconfigurable circuitry such as a PGA or FPGA, or any combination of these possibilities.

The smartphone 101 comprises a camera 701 and a decoder 702 incorporated in the housing of the smartphone 101. The decoder 702 has an input coupled to an output of the camera 701, being arranged to receive a still image or moving image (=multiple subsequent images) captured by the camera 701. Alternatively the decoder 702 could be on external device, e.g. a personal computer or server, and may receive the image from the camera 701 via an external connection (e.g. a wired connection such as USB port, or a wireless connection such as Wi-Fi, Zigbee or Bluetooth) and/or remote connection (e.g. over a network such as a 3GPP cellular network and/or the Internet). The decoder 702 may be implemented in software stored on one or more memories and arranged for execution on one or more processors, or it may be implemented in dedicated hardware circuitry, or configurable or reconfigurable circuitry such as a PGA or FPGA, or any combination of these.

In a localization scenario, the encoder 705 is arranged to encode an identifier of the light source 104 into its emitted light, allowing the smartphone 101 to look up a location of the light source 104 based on the identifier. For example, an identifier of 32 bits may be sent, or a value of 64 or 128 bits that cryptographically encodes the identifier. Typically, the light source 104 repeats the transmission of the identifier one or more times as soon as the first instance of the identifier is sent (perhaps with a short gap to distinguish between instances), thereby maximizing the chance that at least one instance of sending is captured by the camera even in the absence of any synchronization between the phone 101 and the light source 104.

The energy usage of performing camera-based location measurements is a sometimes, but not always, a concern. E.g. the inventor estimates that a phone with an active camera, and some image processing being done to detect the coded light, will consume about 250 mW more than a phone with the camera switched off. If the user is using a live map for five minutes while navigating a shopping mall, then a power drain of about 250 mW during these five minutes due to the smart phone camera being in continuous operation may not be a major concern with respect to the battery lifetime of the phone.

However, for always-on applications like ‘augmented reality’ or ‘push advertising’, where a location signal may be needed for hours on end, if the camera is kept on continuously then the 250 mW drain on the smart phone battery would be significant.

For instance, consider an augmented reality type application such as smart-glasses, where an overlay over the field of view is produced by a heads-up display. To get an accurate and live location/orientation signal without draining the battery too much, a solution would be to switch on the camera briefly e.g. only once every 5 seconds, to take a quick location fix, and to rely on an always-on accelerometer and gyroscope to measure changes in the location/orientation that happen in between. Accelerometer and gyroscope consume only about 10 mW when kept on continuously. In this scenario, the camera is only used occasionally to correct for their drift.

As another example, consider a push based advertising application where a location fix is needed once every 30 seconds, in order to decide if the user has entered a location where an advertisement needs to be served. In this case, accelerometer and gyroscope do not need to stay on continuously, though the accelerometer might be switched on intermittently to determine if the user is walking or standing still. It would be desirable to get a location fix, say, once every 30 seconds by switching on the camera very briefly.

Rolling shutter CMOS cameras as used in phones can be switched on briefly, e.g. to capture one single frame only, and be operated to be in ‘standby’ mode when not used. They consume negligible power in standby mode.

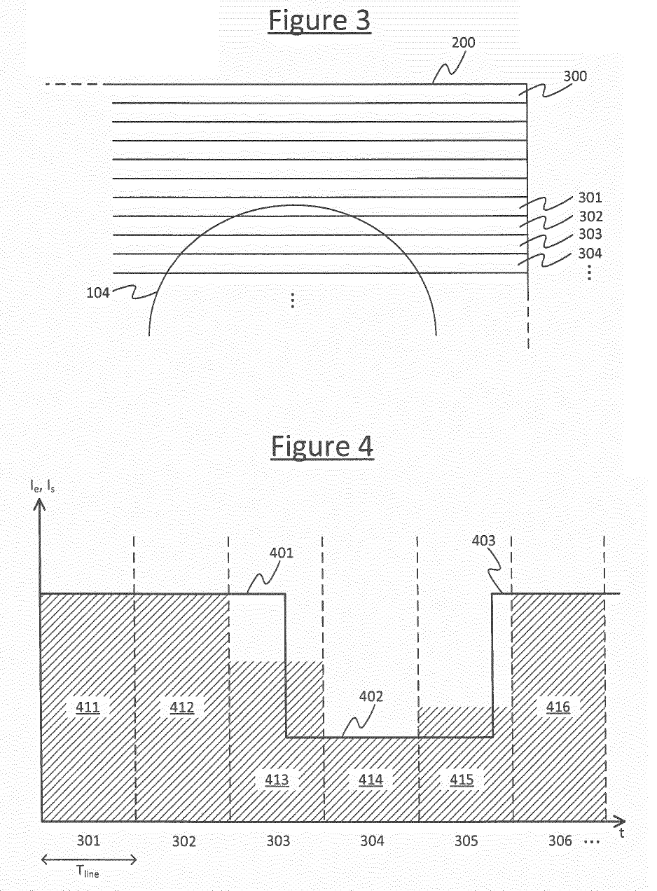

FIG. 2 shows how the coded light sources 103, 104 of FIG. 1 appear in an image 200 captured by a rolling-shutter camera 701, assuming a single frame is captured. FIG. 3 is a magnification of the upper right hand corner of the image 200. As illustrated in FIG. 3, in a rolling-shutter camera the pixels of the image sensor are grouped into multiple lines, typically horizontal rows, corresponding to equivalent lines 300 in the captured image 200. The rolling shutter camera 701 works by exposing each of the multiple lines one-after-another in a sequence (i.e. a temporal sequence). I.e. the camera 701 first begins exposing one of the lines 300 (e.g. the top line or bottom line), then at slightly later time begins exposing the next line in the sequence (e.g. next line down from top or next line up from bottom), and so forth. The camera 701 is characterized by an exposure time Tₑₓₚ, which in the case of a rolling shutter camera is the line exposure time, such that each line 300 is exposed for an instance of the exposure time Tₑₓₚ starting at a different respective point in the sequence.

FIG. 3 shows individual scan lines 301, 302, 303, 304 in which the coded light source 104 appears. Thus the decoder 702 is able to obtain a respective sample from each line, measuring an amount of light sampled from that line. In embodiments, for each line 300, the decoder 702 receives some or all of individual pixel values of that line, and obtains the sample of the line by combining (e.g. averaging) some or all of those individual pixel values received for the line. Alternatively, this combining (e.g. averaging) may be performed by a separate pre-processing stage (not shown) between the camera's image sensor and the decoder 702, e.g. embedded in the camera 701, such that the decoder 702 obtains the combined (e.g. average) sample for each line 300 simply by receiving the line samples from the pre-processing stage. As another example, each line sample could be obtained by taking a single representative pixel value from that line.

By whatever means the line samples are obtained, the decoder 702 thus obtains a sample from each of a plurality of lines 301, 302, 303, 304 . . . in which the coded light appears. As each line is exposed at a slightly different time in a sequence, this means each line 301, 302, 303, 304 . . . captures the coded light at a different moment in time and therefore the modulation encoding the signal can be revealed over the different lines.

Several encodings exist for coded light that can be read with a rolling shutter camera. For instance, DPR (digital pulse recognition) is an encoding that exploits the rolling shutter mechanism so that a code can be read by capturing a single frame. In DPR, the encoding produces an alternating brighter/darker stripe pattern visible over successive camera scan lines in the frame, and the width of these stripes can be measured to extract the coded information. It is assumed here that the rolling shutter exposure time Tₑₓₚ of each scan line 300 is equal to the time Tₗᵢₙₑ it takes to read out a single scan line 300 (i.e. the line period). As will be discussed shortly, in general this is not necessarily always the case and the exposure time Tₑₓₚ is often actually longer (see FIG. 8), but a filter can be applied to recover the samples representing only the light captured during the respective line period and therefore recover the situation represented in FIGS. 4, 5 and 6.

FIG. 4 shows how DPR works in a conventional case. The X axis of the graph is time, the Y axis of the graph is light intensity. The X axis subdivisions 301, 302, 303, 304, 305, 306 show the different times at which each scan line 300 is read. The bold line with segments 401, 402, 403 shows the light intensity Iₑ as emitted by the coded light source 104. The cross-hatched bars 411, 412, 413,414, 415,416 show the amount of light Iₛ as measured by (the relevant pixels of) each scan line 301, 302, 303, 304,305, 306 respectively. In FIG. 4 it can be seen that, in scan line 303, where the emitted signal transits from the high to the low intensity state, an intermediate quantity of light is read out of the scan line 303: the bar 413 is about halfway between the top and bottom levels.

To accurately measure the width of a DPR stripe like 401 or 402, it needs to span multiple scan lines 300. For instance, if the line scan rate is 20 KHz, then only tones with a frequency less than 10 KHz (20 KHz/2) can be distinguished unambiguously. A tone of say 30 KHz will create an ‘aliasing’ effect that will make it look the same as a tone of 10 KHz. Due to aliasing, DPR (and tone based coded light) made using on-off keying (OOK, driving the LED between two signal levels) therefore has a limitation due to aliasing in that the bitrate cannot be higher than ½ of the line scan rate. If multi-level keying is used (stripes with more than two possible amplitudes), bitrates can be somewhat increased, but there remains a fundamental bitrate limitation.

The bitrate limitation above implies that it may take multiple frames to read a coded light source, especially if the number of scan lines 300 in which the coded light source 104 is visible is small. E.g. if a location beacon ID encoded as 32 bits needs to be read, then the frame needs to contain at a minimum of 64 lines (assuming OOK) in which the coded light source 104 is visible. If it is visible in fewer lines, multiple frames need to be captured, and a complex multi-frame re-assembly process is required to ‘stitch’ together the data from the different frames.

It would therefore be advantageous to provide codes that can squeeze more information into a fewer number of scan lines 300. One advantage is faster detection, which can be desirable for its own sake (speedier operation) and/or to save energy (longer battery lifetime for mobile devices because the camera 701 needs to read fewer frames and/or scan fewer lines 300). Alternatively or additionally, another advantage is that coded light sources can be made physically smaller (or be further away and therefore appearing smaller in the image) without impacting battery power consumption in the phone. This can lower the cost of equipping an environment with coded light, and/or can mean that a lower density of coded light sources (of a certain size) is required in a large indoor space because they can be read from further away. And/or as yet another possible advantage, codes that can squeeze more information into fewer scan lines also support the application of higher bitrate data transmission from an emitter to a smart phone camera, e.g. transmitting an MP3 file as quickly as possible.

To address one or more such issues, the following discloses a ‘spiked symbol’ method for encoding information into light to be read using a rolling-shutter camera. According to this spiked symbol encoding, symbols are encoded using short up or down spikes (narrow pulses) in the light level, with the spikes being substantially shorter than the line sampling rate of the camera (and preferably much shorter). The encoding reduces aliasing effects or inter-symbol interference, and in embodiments thereby enables a bit rate twice as high, for the same camera, as known encodings.

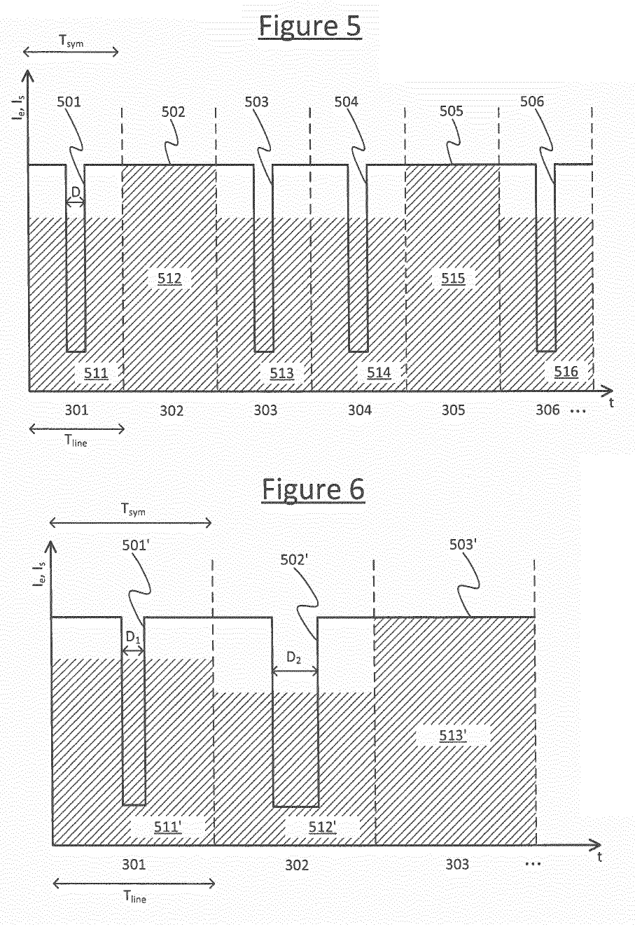

At the receiver side, the rolling-shutter camera 701 may be driven in a particular way to optimize receipt of this spiked symbol encoding. That is, in embodiments, the receiver may be configured to drive the camera 701 to use: (i) a line scan rate fₗᵢₙₑ equal to the clock rate (symbol rate) f_{sym} at which coded light is emitted, and (ii) a shutter time (exposure time) Tₑₓₚ equal to one symbol period T_{sym}. The examples of FIGS. 5 and 6 can be understood most readily by assuming these conditions. However, as will be discussed in more detail later, neither of these two conditions is in general essential for all possible embodiments.

FIG. 5 shows one embodiment of the proposed spiked encoding. In this figure, the line scan rate fₗᵢₙₑ and the symbol clock rate f_{sym} for the coded light emitter are equal. Again the bold line represents the light intensity level Iₑ emitted by the coded light source 104, and the cross-hatched bars represent the light intensity Iₛ sampled by the camera 701. Each of a plurality of the rolling-shutter scan lines 301, 302, 303, 304, 305, 306 samples a respective light intensity level 511, 512, 513, 514, 515, 516, being the total or overall quantity of light sampled in the exposure period of the respective line. According to the spiked coding scheme, a symbol ‘1’ is encoded as a downwards spike 501, 502, 503, 504; and a symbol ‘0’ is encoded by the absence of such a spike 502, 505. This results in a different quantity of light 511, 513, 514, 516 being received in the respective line 301, 303, 304 306 for a ‘1’ symbol relative to the quantity of light 512, 515 received in the respective line 302, 305 for a ‘0’ symbol. Hence the decoder 702 is able to detect the symbol value based on the total or overall amount of light received in the respective line. Further, because the duration (width) D of the spike is substantially smaller than the duration (with) of the time period Tₗᵢₙₑ of a scan line 300, there is little or no aliasing, and clean symbols 1 or 0 are visible in the measured light intensities 511, 512, 513.

FIG. 6 shows a variant of the embodiment of FIG. 5, in which the coding scheme supports more than two possible symbols. Here, a symbol ‘1’ is encoded with a spike 501′ of short duration D₁, a symbol ‘2’ is encoded with a spike 502′ that has longer duration D₂ e.g. being twice as long as D₁ (while still being substantially shorter than the line period Tₗᵢₙₑ), and ‘0’ is again encoded with no spike 503′. Again the different symbols result in different quantities of light 511′, 512′, 513′ being received in the respective line 301, 302, 303, based upon which the decoder 702 can detect the respective symbol value. Further, because the maximum spike width D₂ is substantially smaller than the line period Tₗᵢₙₑ, there is little or no aliasing, and clean symbols 2, 1 or 0 are detectable.

Another possible variant would be, for example, to use ‘no spike’ plus seven different spike widths to encode eight different symbols.

In embodiments, the encoding scheme may be tailored to a particular camera or cameras having a particular line rate Tₗᵢₙₑ, such that the maximum width (e.g. D or D₂) of each spike (each pulse) is less than a certain fraction of the line rate Tₗᵢₙₑ, e.g. less than or equal to one tenth of Tₗᵢₙₑ. However, more generally the coding scheme may be designed at least so that any pulse is restricted to a duration of less than a certain fraction of the symbol period T_{sym} per symbol period, e.g. less than or equal to one tenth of T_{sym}.

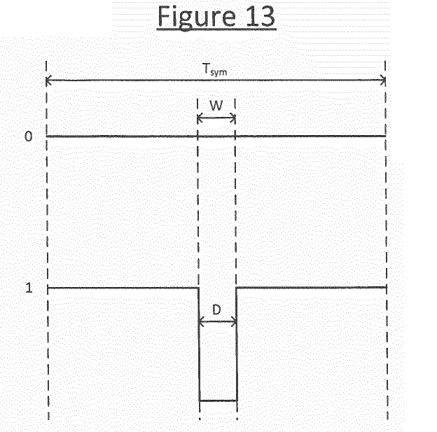

FIG. 13 illustrates the symbol set of FIG. 5. The symbol set comprises a pair of symbol waveforms of duration T_{sym} each representing a different data value, such that in the encoded signal there will be one (and only one) of the symbol waveforms encoding one (and only one) symbol per symbol period. According to the encoding schemes disclosed herein, the any substantive activity in the symbol waveform is restricted to a window W at a given phase within the symbol period, wherein the window W is substantially shorter than the duration of the symbol period T_{sym}. Outside the window W, the waveform is substantially the same for both symbol waveforms in the set, and only inside the window W do any substantial differences between the waveforms exist. In the binary example of FIG. 5, a data value of 0 is represented by a waveform that is substantially flat (the same light level) throughout, both inside and outside the window; and a data value of 1 is represented by a pulse of duration D in the window W (in this case being by definition equal to the duration of the window W).

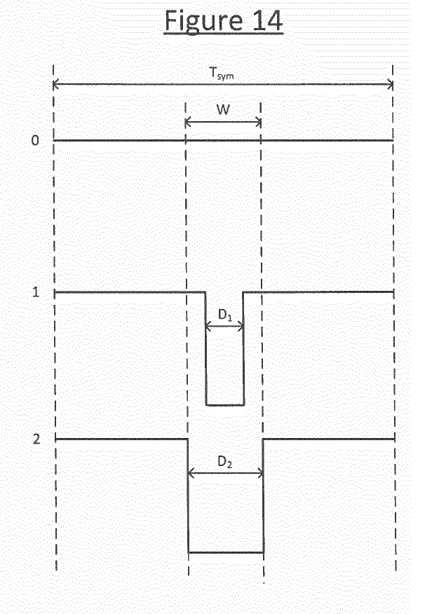

FIG. 14 illustrates the symbol set of FIG. 6, which is configured according to a similar principle. Here the symbol set comprises three (or more) symbol waveforms of duration T_{sym}, wherein again in the encoded signal there will be one (and only one) of the symbol waveforms encoding one (and only one) symbol per symbol period. Here, a data value of 0 is represented by a waveform that is substantially flat (the same light level) throughout, both inside and outside the window W; a data value of 1 is represented by a short pulse of duration D₁ within the window W (being shorter than the duration of the window W); and a data value of 2 is represented by a somewhat longer pulse of duration D₂ in the same window W (which in this case, as the maximum pulse length, is equal to duration as the window W). Therefore again, any substantive activity in the symbol waveform is restricted to a window W at a given phase within the symbol period, wherein the window W is substantially shorter than the duration of the symbol period T_{sym}.

This ensures ‘clear space’ is left between the pulses (spikes′) that encode the actual data. Leaving this clear space between the data-encoding regions of the symbol periods allows the data to be encoded at symbol rate higher than half the sample rate (more than one symbol per two samples, e.g. per two lines of a rolling shutter camera). I.e. there is a region in each symbol period which has the same (clear′) signal level as in every other symbol period, and it is having this clear region, at the same or roughly the same symbol clock phase offset relative to the next symbol, that gives the code its ‘anti-aliasing’ or ‘cross symbol interference reducing’ properties.

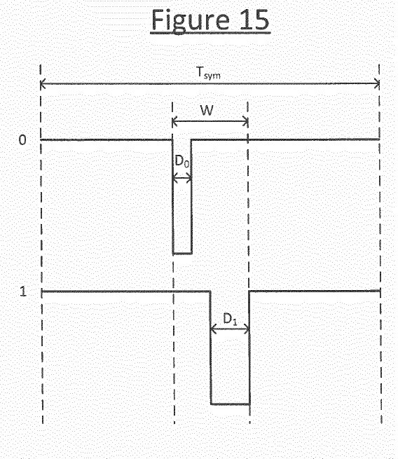

Note that the examples of FIGS. 5, 13, 6 and 14 are not the only possible encoding schemes which meet the disclosed criterion. Another example symbol set having this property is shown in FIG. 15. Here there is provided another example of a binary encoding scheme, this time where a data value of 0 is represented by a pulse of a short duration D₀ and a data value of 1 is represented by a somewhat longer pulse of duration D₁ (e.g. twice as long as D₀). Furthermore, in phase, the pulse D₀ representing 0 does not fall entirely within or even overlap with the pulse D₁ representing a 1. Nonetheless, both pulses fall within a window W at a given phase (i.e. position) within the symbol period having a duration substantially shorter than that of the symbol period T_{sym}. I.e. the different between the earliest edge of the earliest pulse D₀ in the set and the latest edge of the latest pulse D₁ in the set, in terms of their phase within the symbol period as shown in FIG. 15, is equal to W where W is substantially less than T_{sym}.

Further, note that while downwards spikes are shown in the figures, the technique also works if upward spikes are used. Downward spikes may be more appropriate for a lamp, intended as an illumination source for an environment such as room, that also functions as a coded light emitter. Upward spikes are more appropriate for an emitter that aims to use as little energy and/or produce as few human-visible artefacts as possible. Upwards spikes may be more compatible with the aim to have symbols with many bits, because they in theory can make better use of the dynamic range of the camera AD converter. Furthermore, note that the spikes or pulses inside the window W do not necessarily have to be a rectangular or be any particular shape, as long as the symbol waveforms comply with the condition that any substantial differences that exist between them, i.e. the differences that convey the different data values, are restricted to the window W at a given phase (time position) within the recurring symbol period.

In principle, any window duration W that is smaller than T_{sym} will reduce aliasing or cross-symbol interference, but a window duration of no more than 0.2·T_{sym}(20%) is considered a practical limit for the purpose of the present disclosure. A window of this size may be particularly workable if some coarse phase alignment mechanism is used between emit and receive sides. Such a coarse phase alignment could consist of just having slightly different send and receive clock speed, and waiting some time at the receiver until the phases align well enough—this approach is appealing in particular if is desired to duty-cycle the camera to save energy. Further, a larger window size gives a better SNR so more information can potentially be encoded per symbol.

Preferably however, the window duration is in fact shorter than this, no more than 0.1·T_{sym} (10%).

The width of the window W is defined most generally relative to the symbol period T_{sym}, being substantially shorter than T_{sym}. However, in embodiments, the encoding may also be designed specifically for a particular camera or cameras (e.g. particular model or class of cameras) having a particular rolling-shutter line rate Tₗᵢₙₑ. In this case the window W may also be defined relative to Tₗᵢₙₑ, being substantially shorter than Tₗᵢₙₑ. For example W may be restricted to being less than or equal to or less than or equal to 0.1·Tₗᵢₙₑ.

Note, where it said that the symbol waveforms are “substantially” the same outside the window W, or the like, this means the same other than any negligible variations which do not significantly affect the anti-aliasing property of the code, and which are not used by the coding scheme to convey information. For example, if the encoder adds a small amount of noise to the light sent outside the time window W, this would not fall outside the scope of the present disclosure. Also, where it is said herein that the symbol waveforms are “substantially” different inside the window W, this means at least different enough to allow different data values to be detected based on different quantities of light being measured in different respective samples.

Regarding sensitivity, the number of different symbols that can be encoded into a single window of a symbol period is limited by the ability of the smart phone camera to accurately measure the differences in the quantities of light 511′, 512′, 513′ caused by the different symbols. The analogue-digital (AD) converters in typical modern CMOS camera chips can have a dynamic range of 10-12 bits per pixel. The sensitivity limit is however mostly driven by signal-to-noise considerations, especially with short line exposure times. The inventor's experiments have shown that distinguishing more than two quantities of light (using more than two symbols) is realistic for a CMOS camera pointed at a light source with typical indoor light source intensity even when the line exposure time is 1/20,000th of a second (corresponding to a symbol clock and line scan rate of 20,000 symbols/lines per second). It is beneficial in this case to add (or average) together many horizontal pixel values (multiple pixels that see the light source 104) in order to improve the signal/noise ratio. Such adding can be done partially in hardware by most CMOS chips, using a horizontal binning mode. (The use of a horizontal binning mode will usually also help to save energy, though how much depends also on the design of the camera chip.) Some CMOS camera chips support setting the gain level of an analogue pre-amplifier for the pixel signal, before the signal enters the camera analogue-digital (AD) converter: for cameras supporting this it may be desirable to set a high gain.

Regarding phase, where it is said above that the window W is defined in terms of a given phase within the symbol period, this means that the position of the window within the current symbol period relative to the current symbol period is the same as the position of the window in the subsequent, adjacent symbol period relative to that subsequent symbol period, and so forth, even for different symbol values. So from one symbol to the next, the window position does not shift around dependent on the symbol value. However, note that this does not necessarily mean the phase is permanently fixed. E.g. the time offset of the time window within the symbol period may sometimes be changed by the encoder, e.g. in occasional steps. Also, the above condition does not preclude that there may be jitter or a pseudostatic drift in the phase of the encoding, as longs as the degree of jitter or drift is small enough to satisfy the condition that pulses of adjacent symbols don't fall outside the a sufficiently small predetermined window. E.g. if the encoding is designed for the pulses to fall within a window of 0.1·T_{sym} but jitter adds +/−0.05·T_{sym}·, this still satisfies the condition that the pulses fall within a window of 0.2·T_{sym}.

As mentioned, the discussion in relation to FIGS. 4, 5 and 6 assumes that the rolling shutter exposure time Tₑₓₚ of each scan line 300 is equal to the time Tₗᵢₙₑ it takes to read out a single scan line (i.e. the line period Tₗᵢₙₑ, which is the reciprocal of the line rate fₗᵢₙₑ). A CMOS camera under software control can be configured by software to use a (relatively short) exposure time Tₑₓₚ equal to (or sometimes even shorter than) the line period Tₗᵢₙₑ. However, as illustrated in FIG. 8, note that in general it is not necessarily the case that Tₑₓₚ=Tₗᵢₙₑ. Often the exposure time Tₑₓₚ is greater than the line period Tₗᵢₙₑ, such that although the exposure of each scan line 300 begins at different staggered moments in the sequence, their exposure times overlap. Setting the line exposure time Tₑₓₚ to be equal to the line scan time Tₗᵢₙₑ gives a lower complexity. However on the other hand, this may lead to an image that is under-exposed. Though the under-exposure can be corrected by multiplying the pixel values with some factor, the result will be somewhat noisy—of less quality than could be obtained with a longer exposure time. In some applications, where the camera image has more uses than just coded light decoding, it may be beneficial therefore to read the spiked encoding out of an image that has, for example, an exposure time Tₑₓₚ of 4 or 5 times the line sample period Tₗᵢₙₑ and/or symbol clock time T_{sym}.

To accommodate longer exposure times Tₑₓₚ, the decoder 702 may be configured to apply a filter to recover versions of the samples that represent only to the light as received during the respective line time Tₗᵢₙₑ of the respective sample. An example of such a filter is given below.

In classical (frequency-domain) Wiener filtering, one has two independent, stationary, zero mean random processes X and N₀. In a typical application, X represents an input signal input to a filter H, and N₀ represents additive noise added at the output of the filter H. The Wiener filter G is arranged to equalize the filter H, i.e. to undo the effect of the filter H on the input signal X in presence of the noise N (to a best approximation). The classical Wiener filter formulation (in the frequency domain) is:

$$G ( f ) = \frac{{H}^{*} ( f ) S ( f )}{{\vert H ( f ) \vert}^{2} S ( f ) + N ( f )}$$

where S(f) is the spectral density of the input signal X and N(f) is the spectral density of the noise term N₀.

In an application to the detection of coded light with a rolling shutter camera, the equivalent digital signal processing problem corresponds to the restoration of a digital signal that has been filtered by a temporal box function. That is, the input signal X represents the coded light signal as captured by the rolling shutter camera, and the filter H represents the filtering effect of the rolling shutter acquisition process. This filter H is created by the exposure of each line. It amounts to a box function (i.e. rectangular function) in the time domain with a width Tₑₓₚ—i.e. a line is exposed for a time Tₑₓₚ in which time it captures the signal (the transfer function of the filter H in the time domain is uniformly “on”), and before and after that it does not capture any signal (the transfer function of H in the time domain is zero). A box function in the time domain corresponds to a sinc function in the frequency domain. An effect of this filter can be to produce inter-symbol interference. Hence in the following, the filter created by Texp may be referred to in terms of its unwanted effect, as an “ISI filter”.

The task is to find a linear filter G which provides a minimum mean square error estimate of X using only Y. To do this the Wiener filter G is preconfigured based on assumed knowledge of the filter H to be equalized (i.e. undone), as well as N₀. It is configured analytically such that (in theory given knowledge of H and the spectrum of X and N), applying the Wiener filter G to Y (where Y is the input signal X plus the noise N) will result in an output signal X̂ that minimizes the mean square error (MSE) with respect to the original input signal X.

As can be seen from, the formulation of a Wiener filter comprises a representation of the filter to be equalized, in this case in the form of H* and |H|² (=HH*). Traditionally in the classical Wiener filter, it is assumed that H(f), the filter to be equalized, and N(f), the noise spectral density, are exactly known. In the case of equalizing for the ISI filter created by a rolling shutter acquisition process, this implies exact knowledge of Tₑₓₚ. It is also assumed that the spectral densities S(f) and N₀(f) of the processes X and N, respectively, are known.

However, Wiener filters are in fact very sensitive to errors in the estimation of H(f). Some techniques have been developed in the past to deal with an unknown distortion, such as: iterative (time-consuming) approaches, where one tries to vary the target response until one gets the best result; or min-max approaches, where one tries to identify the worst case H(f) and optimizes the Wiener filter for this. However, the filter to be equalized may still not be known very accurately.

Therefore to undo the ISI at the receiver side, it would be desirable to provide a more “powerful” equalizer filter that is insensitive to inaccuracies in the definition of H(f). In embodiments, this can be achieved by computing a fixed “average Wiener filter”, a Wiener-like filter that is robust under unknown variations of the ISI filter H(f). This “robust Wiener filter” can produce a more optimal output in terms of MSE, given a statistical distribution of the relevant parameters of H(f).

In an application to coded light, this theory allows one to reconstruct a coded light signal where Tₑₓₚ of the camera is only known approximately, which can often be the case.

In the following the problem is described in the frequency domain (so in terms of H(f), as introduced before). Note that in an application to coded light, the robust Wiener filter may be constructed in real time in a camera-based (smart phone) decoding algorithm, as Tₑₓₚ, and therefore H(f), is defined or changed during the actual read-out of a lamp.

The robust Wiener filtering is based on noting that H(f) is not known exactly, but may in fact be dependent on at least one unknown quantity θ, i.e. a parameter of H whose value is not known and may in fact in any given case be found within a range of values, e.g. between two limits −Δ and +Δ (or more generally Δ1 and Δ2). That is, it is assumed that the filter H(f;θ) depends on a random parameter θ, independent of X and N.

For a box function of width θ, i.e. a sinc in the frequency domain, one may write:

$$H ( F ; θ ) = \frac{sin ( πθ f )}{πθ f}$$

And in the case of an ISI filter created by the box, θ is Tₑₓₚ.

The robust Wiener filter is then created by taking the classical Wiener filter representation given above, and where a representation of the filter to be equalized appears, replacing with a corresponding averaged representation that is averaged over the potential values of the unknown parameter θ (e.g. average between −Δ and +Δ or more generally Δ1 and Δ2). That is, wherever a term based on H(f) appears, this is replaced with an equivalent averaged term averaged with respect to θ.

Starting from the classical formulation above, this gives:

$$G = \frac{{E}_{θ} [ {H}^{*} ] \cdot S}{{E}_{θ} [ {HH}^{*} ] \cdot S + {𝒩}_{0}}$$

where E is the average with respect to θ

Given the example above, it can thus be seen that it is not necessary in all embodiments that Tₑₓₚ=Tₗᵢₙₑ. Also, in such cases, the scope of the disclosure is not just limited to the filters described here, and other types of filter such as other types of equalizer may also be applicable for undoing the inter-symbol effect of the exposure time Tₑₓₚ, and thereby recovering samples corresponding to the line time Tₗᵢₙₑ.

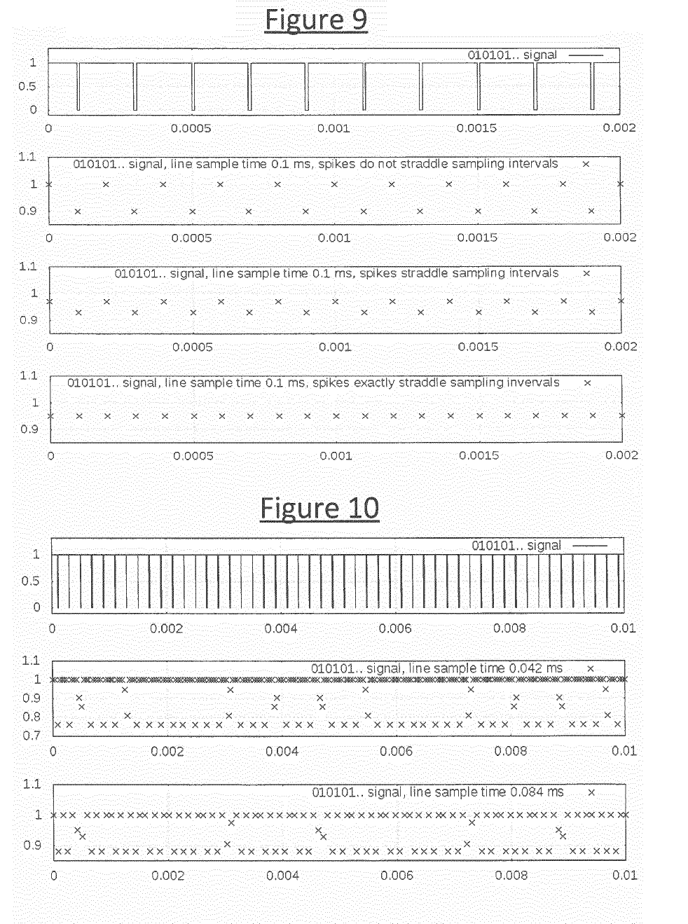

Further, so far, the embodiments described above have been explained in terms of the line scan rate fₗᵢₙₑ being exactly the same as the symbol clock rate f_{sym}, but this is also not necessary for all possible embodiments. For example, this may have a disadvantage in that if the phase difference of the clock is such that a spike overlaps the boundary between the exposure period of two scan lines, the symbols cannot be sampled without ambiguity. By keeping the spike widths small, e.g. 1/10^{th} of the scan line time, the chance of this happening is only 1 in 10. Such issues are discussed in more detail in relation to FIGS. 9, 10, 11 and 12.

First consider a case where the line sampling rate of the camera is exactly equal to the symbol clock rate of the transmitter. As an example, say that both use a 10 kHz clock. This gives a symbol duration of 0.1 ms. Say that the spike width is 1/10th of the symbol duration, so 0.01 ms. The CMOS camera reads lines at 10 kHz, so (as long as it is sampling scan lines that have light from the light source in view) it yields one sample of the coded light from the emitter every 0.1 ms. Assume in this example that the line exposure time is also 0.1 ms. Each sample averages the light received over a 0.1 ms time interval.

FIG. 9 illustrates this arrangement. In the graphs in this figure, the X axes all denote time (in seconds), and the Y axes denote light levels transmitted (top graph) or quantities of light received in a sample (bottom three graphs). In the bottom three graphs, each cross plots a single line sample value as obtained from the camera. The code used has two symbols: a ‘0’ denoted by a constant ‘on’ light level during its the symbol sending period; and a ‘1’ denoted by a spike being inserted at the start of the symbol period, being a spike in which the light is off for 0.01 ms. The top graph in the figure illustrates the light levels due to the sending of an example symbol sequence ‘0101010 . . . ’, so alternate ‘0’ and ‘1’ symbols.

The second graph from the top shows the samples taken from the coded light in the top graph, in the case that the spikes (and the windows in which a spike can be placed) do not straddle the sample boundaries—each spike occurs is fully within the sample period of a single sample. It can be seen that the subsequent samples show the quantities of light 1 and 0.9, corresponding to the ‘0’ and ‘1’ symbols.

Now consider what happens when the spikes straddle two sample periods. In this case, a single sample period sees a spike or lack-of-spike from two adjacent symbols: there is cross-symbol interference in the samples. The third graph from the top shows a sampled signal when the spikes straddle two sample periods, but where each spike has unequal parts in the two subsequent sample periods: in this case there is more of a spike in the first sample period than in the next sample period. The symbols interfere with each other, but not to the extent that the value of the symbol which makes the largest contribution in the sampling period can no longer be detected. Note however that the figure does not show sampling noise: it was created by a simulation that assumes zero sampling noise. If there is some sampling noise, it may no longer be possible to filter away the less-contributing symbol with accuracy.

In the bottom-most graph of FIG. 9, it is shown what happens when the middles of the spikes exactly align with the sample boundaries. In this case, the 010101 . . . symbol sequence no longer creates a detectable signal: the symbols interfere fully destructively.

With a spike size of 1/10^{th} of the symbol clock time, and assuming no measures are taken to phase-synchronize the emitter and receiver clocks, but that their phase difference is left to chance, there is only a 1 in 10 chance that the spikes straddle the sampling boundary.

Still, this 1 in 10 chance presents a reliability problem. One could simply live with the 1/10 reliability. However, if it is desired to improve on this then there are several solutions, now discussed.

A first option is to use a phase synchronization mechanism between sender and receiver, in order to avoid phase differences that make spikes straddle a sampling interval. A somewhat small window size containing spiked symbols ensures that such synchronization mechanisms do not need to be very accurate compared to systems that use non-spiked symbols. One possible implementation of such a mechanism is that, when the receiver detects it is in a bad-phase situation, it stops and re-starts the CMOS camera chip clock, to create (hopefully) a good-phase situation. Another possible implementation is that the receiver uses a back-channel to the transmitter, in order to tell the transmitted to change its phase, but in general we want to avoid design options that require a back-channel, for cost and simplicity reasons.

A second option is that the transmitter regularly changes the phase of its transmitter clock, or changes the time offset position that the spikes occupy inside their symbol periods. Thus, a receiver in a bad-phase situation can just wait until the transmitter changes the phase. For example, the phase could be advanced by 2/10ths of a symbol period after each message. As another example, the phase could be advanced by 2/10ths after each 4 bits in a message, where the message is encoded with an error correcting code so that, if 10% of the bits in the message are unreadable, it the message can still be re-constructed.

A third option is for the receiver to use a sampling period length that is less than or equal to the length of a symbol minus the (largest possible) spike length (or more generally minus the length of the window W). This ensures that two spikes or non-spikes in adjacent symbols can never both contribute at the same time to the quantity of light measured in a single line sample. Thus, cross-symbol interference in every sample is avoided.

This third option is illustrated in FIG. 10. The axes and symbols in FIG. 10 are as in FIG. 9. The top-most graph shows the transmitted signal, with a 0.1 ms symbol length and a 0.01 ms spike length: note that the transmitter is not making any clock phase or spike offset adjustments on its own, in the time period shown (unlike the second option above). The second graph from the top shows the samples in a receiver with sample times (sample lengths) of 0.042 ms. Most samples show the normal quantity of light of 1: the absence of any spike. Some samples show a clear spike, falling within the sample boundaries, yielding a quantity of light around 0.76. Some spikes straddle two adjacent samples, leading to intermediate quantities of light, between 1 and 0.76, in both. The average quantity of light of such two adjacent samples is always 0.88: exactly between 0.76 and 1. By finding the samples with the intermediate quantity of light in the sequence, and noting their positions, the decoder can recover the frequency and phase of the sender clock with some accuracy. Based on these, it is easy to identify to map the (possible) spike positions in the symbols to the position of the sample(s) that need to be considered to measure the (presence, absence, or length) of the spikes. The third graph from the top in FIG. 10 also illustrates the third option, this time with a sampling time of 0.084 ms.

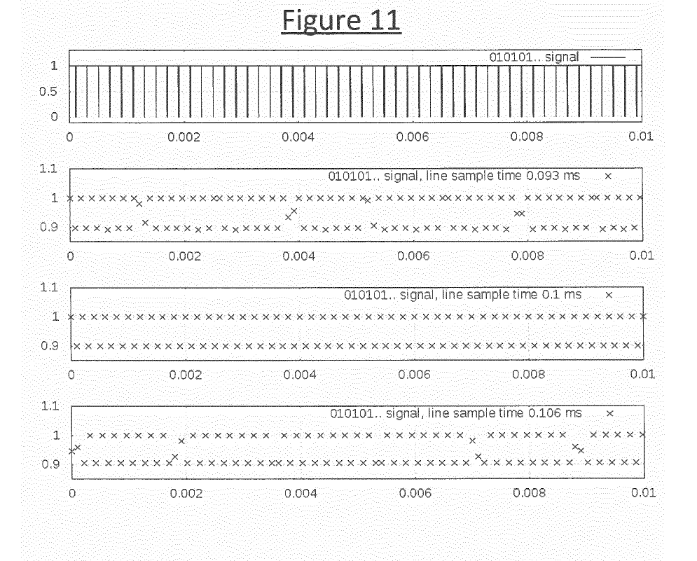

A fourth option is to use a receiver sampling period length that is longer than in the third option above, but not exactly equal to the symbol length. For example, the sampling time could be 0.093 ms, as illustrated in the second graph from the top in FIG. 11. The signal and axes in FIG. 11 are the same as in FIG. 10. With a sampling time of 0.093 ms, again pairs of samples with intermediate values can be seen, in this case intermediate between 0.9 and 1, and there is cross-symbol interference in at least one of the samples. This interference might sometimes be resolved, as discussed earlier in the context of FIG. 9, but it cannot necessarily always be resolved. To address this, an error correcting code can be used to compensate for the at-most-10% of the symbols that cannot be read.

The bottommost graph in FIG. 11 shows a sampling length of 0.106 ms. It can be seen that still, many of the symbols can be cleanly read: their spikes (or lack-of-spikes) fall within a single sample. But again, there is cross-symbol interference, and this time this cross-interference affects slightly over 10% of the symbols. To recover, given adverse noise conditions, a stronger error correcting code may be used than in the case of the 0.093 ms sampling time.

In case that a transmitter repeats the same message multiple times, for example a beacon message by a transmitter that is a location beacon, an alternative to the use of error correcting codes is possible. To compensate for missing symbols, the receiver can wait and read a second copy of the message, with the expectation that different symbols will be missing (i.e. unreadable from the samples because of cross-symbol interference) in the second copy of the message. The receiver can keep reading messages, or fragments of messages, until all needed symbols have been successfully read. Thus the repeated messages provides an alternative way of performing error correction at the receiver.

Thus, above have been disclosed various techniques, applicable to transmitters and receivers, that can be combined to build successful combinations that can deal with phase synchronization issues, and the issue of different clock speeds in transmitters and receivers.

As the line sampling rate of a CMOS camera is typically steered by a crystal-driven clock, different cameras can have slight differences between their line rates, and a single camera might also have slightly different rates when exposed to very high or low environmental temperatures. A low-cost coded light transmitter might not even have a crystal-driven clock, so its clock speed might change significantly (in the single-digit percent values) depending on environmental temperature. Overall, trying to achieve an exact synchronization between transmitter and receiver clocks is a somewhat costly proposition. The use of techniques to detect and compensate for clock speed and phase misalignment may therefore be preferred when cost considerations play a role.

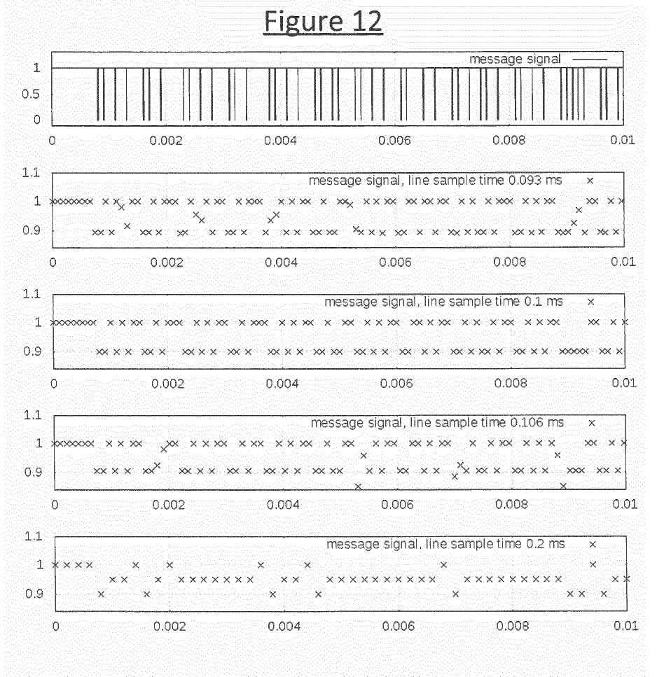

FIG. 12 shows an additional example of how a message can be sampled. The axes and symbols are the same as in FIG. 10, but this time, a real message is being shown, not the symbol sequence 010101. The Figure shows a message that starts with a carrier signal: 8 ‘0’ symbols followed by two ‘1’ symbols. The bottom-most graph in FIG. 12 shows somewhat of an outlier case: the message is sampled with a sample length that is twice the symbol length. The graph shows that two adjacent ‘00’ and ‘11’ symbols will produce sample values of 1 and 0.9, whereas adjacent ‘10’ and ‘01’ symbols produce values of 0.95. This means that some of the information from the message can still be read, even though the sample clock is much below the symbol clock. A very strong error correcting code, or a subsequent reading of many copies of the same message while the phase alignment is changed, could eventually recover the entire message contents. However, a code with a 0.1 ms symbol length is not very well matched to a receiver with a 0.2 ms sampling time: if such receivers are to be supported, then a code with a symbol length in the area of 0.2 ms will lead to a higher effective bit-rate, and simpler construction, for these receivers.

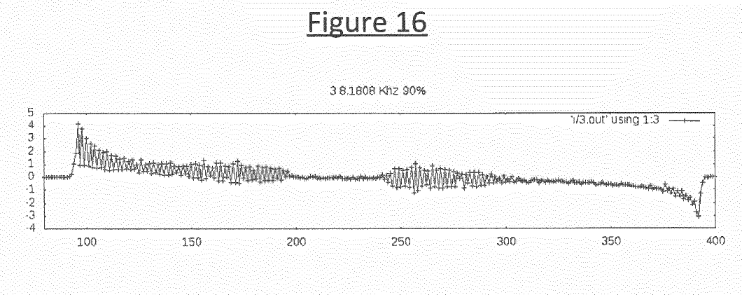

FIG. 16 shows some experimental results with a window size of 0.2·T_{sym} (20%) and the encoding scheme of FIG. 5, encoding a sequence of symbols ‘01010101 . . . ’, with detection performed using camera, having a line sampling rate of 16274 Hz. A block wave generator was used to put a 8.1808 kHz block wave onto a LED lamp, with a 90% duty cycle, so 90% of the time the light is on, 10% it is off. This corresponds to a spiked symbol encoding symbol train with a 16361.6 Hz symbol clock, alternately encoding ‘1’ and ‘0’ symbols, with a symbol with of 2/10th of the clock period. The camera exposure time Tₑₓₚ was set to equal the line period Tₗᵢₙₑ. The graph of FIG. 16 was obtained taking a vertical slice through the image containing the light source 104, and adding up the luminance values for each horizontal scan line 301, 303 . . . , and plotting the difference in luminance over the scan lines. The scan line numbers are shown on the X axis and the differences on the Y axis. Two parts of the line can be seen in the graph, parts from X=100 to X=180, and X=240 to X=280, where the difference between ‘1’ and ‘0’ symbols is clearly visible in the line. In the part X=180 to X=240, the symbols straddle the line sampling boundaries, so they become invisible. The camera used in this experiment was a 640×480 resolution camera available in a common tablet computer. Some software noise reduction was done on the camera signal being plotted, and this noise reduction likely contributed to the relatively abrupt transitions in the nature of the signal at X=180 and X=240. Other cameras and other noise reduction algorithms may create slightly different experimental results. It may be desirable that noise reduction processing for the camera signal switched off, if possible, when obtaining camera signal from a camera 701 that is input into the decoder 702. However, this will not be possible on all possible camera platforms.

Some further optional features are now described, any one or more of which may be used in conjunction with the disclosed encoding and decoding schemes disclosed herein.

In embodiments, the lighting element 703 may comprise one or more LEDs. For example, with a symbol clock of 20,000 lines per second, the maximum pulse width will be e.g. 1/200,000 second. This means that when this signal encoding is used to drive a commonly-used phosphor-based white LED, the spike will only be faithfully reproduced in the blue light component of the emitted light—the phosphor will slightly smooth out the spike shape shown in the yellow (lower-frequency) component of the light. In some situations, in embodiments that do not try to keep clock phases synchronized, it is therefore preferred to use the blue component (blue pixels as measured by the camera) only, especially for symbols that are close to the edge of the exposure interval with respect to their phase.

In further embodiments, the encoder may be configured to mix multiple codes. That is, the coded light emitter might emit both a ‘fast’ spiked code and a ‘slower’ DPR-based or symbol-based code in an interleaved way, in order to be backwards compatible with other types of coded light detectors. In that case, it may be beneficial if the fast code is emitted at a predictable rate. The smart phone can then activate its camera to take a snapshot of a light source exactly when it knows that the next fast code is coming up.

In further embodiments, the camera may be configured to capture only a sub-region of the potential image area, in order to save on power consumption. Cameras under software control can be programmed to sample only a subset of the pixels, sometimes called a “region of interest” (ROI), or spatial window, within the entire field of view. In embodiments of the present discourse, this technique can be used to save even more power: the power usage of sampling a small window is usually proportionally smaller, compared to sampling the full frame. The use of ROIs to save power does require however that the smart phone has some idea of where the coded light source of interest is likely to be in the field of view.

For example, the location of the light source could be detected by an image recognition algorithm, or manually specified by the user. Further, an accelerometer and/or gyroscope may be used to track the movement of the phone. In this case, the window may be placed and sized to cover the likely position of the coded light source, which is determined based on its earlier position in the field of view, and the measured movement of the phone in the meantime. A surrounding frame of pixels can be added to the window, sized to account for the worst case accelerometer/gyroscope drift. By allowing for a smaller window to be used to capture the code, the disclosed encoding scheme enhances the power saving potential of this technique, compared to known encodings.

A further addition to the technique may operate as follows. First, the camera is set to capture a single frame at very low resolution—this can be done using less power than capturing a full-resolution frame. This frame is analyzed to find locations with high brightness: possible light sources that may include coded light. Then, these locations are sampled again with a small ROI (window) at higher resolution, until (sufficient) coded light sources have been found and decoded. Again, it is noted that by allowing for a smaller window to be used, the disclosed encoding scheme enhances the power saving potential of this technique, compared to known encodings.

In yet further embodiments, the codes may be optimized for multiple line scanning rates. A typical 640×480 resolution CMOS camera is capable of producing a frame rate up to 30 fps. This means that 30*480=14,400 lines per second are output at most. Because these cameras work with a ‘vertical blanking interval’, a period between frames where no lines are output, the actual line scanning rate is actually slightly higher than 14,400 lines per second. For one such camera tested, it was 16274 lines per second: a line sampling rate of 16274 Hz. A spiked symbol encoding clock slightly lower than 16274 Hz would therefore be optimal, according to one embodiment. When encoding one bit per symbol, this would mean a physical layer bitrate of about 16 Kbit/s.

Modern phones (or tablets) tend to come with one camera on each side, with one typically being a 640×480 resolution camera intended mainly for video conferencing, and the second a higher-resolution camera for taking pictures. Say this second camera has a capacity to capture 1920×1080 video at 30 fps. This corresponds to a line sampling rate of about 35 kHz. For this camera, a higher 35 kHz symbol clock, meaning a 35 Kbit/s bit rate would be optimal in embodiments.

In one embodiment, a coded light emitter may therefore emit coded light messages, with the different symbol clock rates like 16 kHz and 35 kHz, in an interleaved way, with each message and clock rate occurring at predictable times (e.g. at fixed time intervals), so that the appropriate camera can be switched on only at the right time, saving energy.

In another embodiment, a code would be used that can be read by both types of cameras. For example, a symbol encoding clock of 16×2=32 kHz could be used, with spike widths of 1/10th of the symbol coding clock rate. This would allow a 1920×1080 camera to capture 9/10th of all symbols in a clean way. The 640×480 camera however will see, if there is no overlap with the sides of the scan line time interval, two symbols a and b in a single scan line, so it will read the light value a+b, and then only for 8/10th of all symbol pairs a and b. Assuming the symbols are binary, the 640×480 camera would see three signal levels, one for a=b=0, one for a+b=1, and one for a=b=1. An error correcting code can be used to compensate for the missing information, allowing the 640×480 camera to decode the whole message after sampling enough 3-level signals. Different code designs are possible, making different tradeoffs between the overheads when being read by the 1920×1080 camera versus the 640×480 camera.

As mentioned previously, in embodiments the encoder may send the same message multiple times and change phase between messages, to increase the chance of detection by a larger number of receiving devices. More generally the technique need not change phase only between messages. Rather, it may be beneficial in some embodiments to change the phase often—even to change the phase during the sending of a single beacon message, so as to limit the number of lost symbols in the message to a low percentage, allowing error correcting codes to work. In such cases, the phase may be altered at least once after sending at least two symbols with constant phase. Further, in embodiments, it can also be advantageous to alter the symbol rate between beacon messages, to better support power saving in a range of cameras; but again, more generally the technique need not be restricted to changing symbol rate only between messages, and this may also be changed during the sending of a single message.

As a further consideration, the different symbol waveforms as discussed here produce different light levels for different symbols. This creates the possibility that a coded light source also used for illumination might show a visible ‘flicker’ if certain symbol sequences are transmitted. For example, with a symbol clock of 10 kHz and symbols as shown in FIG. 15, with, if one repeatedly transmits one thousand ‘0’ symbols followed by one thousand ‘1’ symbols, this may result in a noticeable 5 Hz flicker being visible in the emitted light. Therefore, in embodiments it may be desirable to use a message encoding scheme that has flicker-reducing or flicker-avoiding properties, and/or a scheme that avoids long sequences of symbols where on average one symbol occurs significantly more often in the sequence than others. One possible scheme is to encode messages using an error correcting code that has the property that the code sequences produced always contain an equal number of ‘1’ and ‘0’ symbols. In general, the problem of flicker reduction or avoidance can be solved by using a code construction scheme that yields a ‘DC-free’ or ‘DC-balanced’ code: many such schemes are known.

It will be appreciated that the above embodiments have been described only by way of example.

For instance, the disclosed techniques are not just applicable to smart phones. In other embodiments, the disclosed encoding and decoding schemes may be used with any receive side equipment, either mobile or fixed, and either with camera and decoder incorporated into same unit or being external or even remote to one another. Similarly, the disclosed encoding and decoding schemes may be used with any light source at the transmit side, whether a luminaire having a primary function of illuminating a room such as an environment, or a dedicated coded light source; and whether the light source has its encoder, driver and light emitting element(s) incorporated into one unit or two or more units external or even remote from one another.

Furthermore, the disclosed techniques are not just applicable to detection using a rolling-shutter camera. Alternatively, the disclosed encoding and decoding schemes can also be valuable in combination with other forms of sensor being used as a detector, e.g. a photodiode connected to a slow A/D converter, or a global shutter camera with a fast enough frame rate. In such cases, references above to “lines” become more generally “samples”, references to the line rate fₗᵢₙₑ become more generally the sample rate fₛₐₘₚ, and references to the line period Tₗᵢₙₑ become more generally the sample period Tₛₐₘₚ.

Furthermore, the scope of the disclosure is not limited to just localization applications or just to encoding an identifier of the light source, and in general the disclosed encoding and decoding schemes can be used for communicating any kind of data. Also, note that while in preferred embodiments the whole code is captured in a single frame, this is also not essential in all possible embodiments. If the code requires two or more frames to be seen completely enough for decoding, a ‘stitching’ process may be used to combine the parts of the code received in the different frames.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An encoder for encoding symbols of data into light emitted by a light source for detection by a light sensor, said light sensor configured to sample the light at a sample rate fₛₐₘₚ having a sample period Tₛₐₘₚ=1/fₛₐₘₚ; wherein:
the encoder is configured to encode the symbols into the light at a symbol rate f_{sym} having a symbol period T_{sym}=1/f_{sym};
each of said symbols is encoded as one symbol waveform of a set of at least two different symbol waveforms formed in a level of the emitted light as a function of time, each of the symbol waveforms representing a different respective data value of a corresponding set of different data values;
the difference between the symbol waveforms, is formed only within a predetermined time window, the predetermined time window being at a given phase within the symbol period and having a duration less than 0.2·T_{sym}, the light level inside said time window being substantially different for the different symbol waveforms, and the light level outside said time window being substantially the same for the different symbol waveforms; and
the symbol rate f_{sym} is higher than half the sample rate fₛₐₘₚ.

2. The encoder of claim 1, wherein the encoder is configured to alter the phase at least once, and to continue said encoding with the altered phase.

3. The encoder of claim 1, wherein the encoder is configured to alter the symbol rate at least once, and to continue said encoding with the altered symbol rate.

4. A decoder for decoding symbols of data encoded into light emitted by a light source, wherein:
the decoder is operable to obtain samples of the light sampled at a sample rate fₛₐₘₚ having a sample period Tₛₐₘₚ=1/fₛₐₘₚ;
the symbols are encoded in the light at a symbol rate f_{sym} having a symbol period T_{sym}=1/f_{sym};
each of said symbols is encoded as one symbol waveform of a set of at least two different symbol waveforms formed in a level of the emitted light as a function of time, each of the symbol waveforms representing a different respective data value of a corresponding set of different data values;
the difference between the symbol waveforms, is formed only within a predetermined time window, the predetermined time window being at a given phase within the symbol period and having a duration less than or equal to 0.2·T_{sym}, the light level inside said time window being substantially different for the different symbol waveforms, and the light level outside said time window being substantially the same for the different symbol waveforms;
the decoder is configured to detect the data values represented by the symbol waveforms of the symbols, based on a quantity of light sampled during each of a plurality of respective instances of the sample period; and
the sample period Tₛₐₘₚ is greater than or equal to half the symbol period T_{sym}.

5. The decoder of claim 4, wherein the sample period Tₛₐₘₚ is less than or equal to T_{sym} minus the duration of the predetermined time window.

6. The decoder of claim 4, wherein the decoder comprises an error correction algorithm to correct for symbols missed due to cross-symbol interference.

7. The encoder of claim 1, wherein the duration of said predetermined time window is less than or equal to 0.1·T_{sym}.

8. The decoder of claim 4, wherein said samples are sampled at a sample rate fₛₐₘₚ having a sample period Tₛₐₘₚ=1/fₛₐₘₚ, and the duration of said predetermined time window is less than or equal to 0.1·T_{sym} and less than or equal to 0.1·Tₛₐₘₚ.

9. Receiving equipment comprising the decoder of claim 4, and a rolling-shutter camera having an image sensor for capturing an image of said light, wherein:
each of said samples corresponds to a respective one of a plurality of lines in the image, the rolling-shutter camera capturing the lines at different respective times in a sequence.

10. The receiving equipment of claim 9, wherein the rolling shutter captures the lines at a line rate fₗᵢₙₑ having a line period Tₗᵢₙₑ=1/fₗᵢₙₑ, and each line is exposed for an exposure time Tₑₓₚ that equal to Tₗᵢₙₑ.

11. The receiving equipment of claim 9, wherein the rolling shutter captures the lines at a line rate fₗᵢₙₑ having a line period Tₗᵢₙₑ=1/fₗᵢₙₑ, and each line is exposed for an exposure time Tₑₓₚ that is greater than the line period Tₗᵢₙₑ; and the decoder comprises a filter arranged to filter measurements from said plurality of lines in order to obtain said samples, such that each of said samples after said filtering represent an intensity of the light as received during a time period shorter than that of the exposure time Tₑₓₚ.

12. The receiving equipment of claim 9, wherein the camera is configured to capture pixels from only a sub-region of the image sensor, the sub-region comprising or consisting of a region in which the light source appears.

13. A method of encoding symbols of data into light emitted by a light source for detection by a light sensor, said light sensor configured to sample the light at a sample rate fₛₐₘₚ having a sample period Tₛₐₘₚ=1/fₛₐₘₚ, wherein:
the symbols are encoded into the light at a symbol rate f_{sym} having a symbol period T_{sym}=1/f_{sym};
each of said symbols is encoded as one symbol waveform of a set of at least two different symbol waveforms formed in a level of the emitted light as a function of time, each of the symbol waveforms representing a different respective data value of a corresponding set of different data values;
the difference between the symbol waveforms, is formed only within a predetermined time window, the predetermined time window being at a given phase within the symbol period and having a duration less than 0.2·T_{sym}, the light level inside said time window being substantially different for the different symbol waveforms, and the light level outside said time window being substantially the same for the different symbol waveforms; and
the symbol rate f_{sym} is higher than half the sample rate fₛₐₘₚ.

14. A method of decoding symbols of data encoded into light emitted by a light source, wherein:
the symbols are encoded in the light at a symbol rate f_{sym} having a symbol period T_{sym}=1/f_{sym};
each of said symbols is encoded as one symbol waveform of a set of at least two different symbol waveforms formed in a level of the emitted light as a function of time, each of the symbol waveforms representing a different respective data value of a corresponding set of different data values;
the difference between the symbol waveforms, is formed only within a predetermined time window, the predetermined time window being at a given phase within the symbol period and having a duration less than or equal to 0.2·T_{sym}, the light level inside said time window being substantially different for the different symbol waveforms, and the light level outside said time window being substantially the same for the different symbol waveforms;
the method comprises obtaining samples of the light sampled at a sample rate fₛₐₘₚ having a sample period Tₛₐₘₚ=1/fₛₐₘₚ and detecting the data values represented by the symbol waveforms of the symbols, based on a quantity of light sampled during each of a plurality of respective instances of the sample period;
wherein the sample period Tₛₐₘₚ is greater than or equal to half the symbol period T_{sym}.

15. A computer-program product for decoding symbols of data encoded into visible light emitted by a light source, the computer program product comprising software embodied on one or more computer-readable storage media, being retrievable or downloadable therefrom; wherein:
the symbols are encoded in the light at a symbol rate f_{sym} having a symbol period T_{sym}=1/f_{sym};
each of said symbols is encoded as one symbol waveform of a set of at least two different symbol waveforms formed in a level of the emitted light as a function of time, each of the symbol waveforms representing a different respective data value of a corresponding set of different data values;
the difference between the symbol waveforms, is formed only within a predetermined time window, the predetermined time window being at a given phase within the symbol period and having a duration less than or equal to 0.2·T_{sym}, the light level inside said time window being substantially different for the different symbol waveforms, and the light level outside said time window being substantially the same for the different symbol waveforms;
the software of the computer program product is further configured so as, when executed on the one or more processors, to obtain samples of the light sampled at a sample rate fₛₐₘₚ having a sample period Tₛₐₘₚ=1/fₛₐₘₚ and detect the data values represented by the symbol waveforms of the symbols based on a quantity of light sampled during each of a plurality of respective instances of the sample period;
wherein the sample period Tₛₐₘₚ is greater than or equal to half the symbol period T_{sym}.

16. A signal for output via a light source to encode symbols of data into visible light emitted by the light source for detection by a light sensor, said light sensor configured to sample the light at a sample rate fₛₐₘₚ having a sample period Tₛₐₘₚ=1/fₛₐₘₚ, wherein:
the symbols are encoded at a symbol rate f_{sym} having a symbol period T_{sym}=1/f_{sym};
each of said symbols is encoded as one symbol waveform of a set of at least two different symbol waveforms formed in a level of the emitted light as a function of time, each of the symbol waveforms representing a different respective data value of a corresponding set of different data values;
the difference between the symbol waveforms, is formed only within a predetermined time window at a given phase within the symbol period, the predetermined time window having a duration less than or equal to 0.2·T_{sym}, the light level inside said time window being substantially different for the different symbol waveforms, and the light level outside said time window being substantially the same for the different symbol waveforms; and
the symbol rate f_{sym} is higher than half the sample rate fₛₐₘₚ.
